(19) United States
(12) Patent Application Publication
(10) Pub. No.: US 2026/0011771 A1
(43) Pub. Date: Jan. 8, 2026

(54) LITHIUM SECONDARY BATTERY AND CONTROL METHOD THEREOF

(71) Applicant: SEOUL NATIONAL UNIVERSITY R&DB FOUNDATION, Seoul (KR)

(72) Inventors: Jang Wook Choi, Seoul (KR); Tae Yong Lee, Seoul (KR)

(21) Appl. No.: 19/327,979

(22) Filed: Sep. 12, 2025

Related U.S. Application Data
(63) Continuation of application No. PCT/KR2024/003201, filed on Mar. 13, 2024.

(30) Foreign Application Priority Data
Mar. 15, 2023 (KR) 10-2023-0033834

(51) Int. Cl. H01M 10/0525; H01M 4/02; H01M 4/38; H01M 4/40; H01M 4/485; H01M 10/44

(52) U.S. Cl. CPC H01M 10/0525; H01M 4/386; H01M 4/405; H01M 4/485; H01M 10/446; H01M 2004/021; H01M 2004/027

(57) ABSTRACT

A lithium secondary battery with extended lifetime and improved electrochemical performance, and a control method thereof, are provided.

According to one embodiment of the present invention, there is provided a lithium secondary battery comprising: a cathode; an anode; a separator interposed between the cathode and the anode; and an electrolyte; wherein a reversible capacity ratio (N/P Ratio) of the cathode to the anode is 1.2 to 4.0, and the anode comprises an anode active material comprising lithium.

### CROSS-REFERENCE TO RELATED APPLICATIONS

This application is a Continuation of Application No. PCT/KR2024/003201, filed on Mar. 13, 2024, which in turn claims the benefit of Korean Patent Application No. 10-2023-0033834, filed on Mar. 15, 2023. The entire disclosures of all these applications are hereby incorporated by reference.

### TECHNICAL FIELD

The present invention relates to a lithium secondary battery and a control method thereof, and more specifically, to a lithium secondary battery and a control method thereof in which an anode comprising lithium is used, and in which the ratio (N/P ratio) of the anode capacity to the cathode capacity and the charge/discharge state of charge (SOC) range are controlled so as to improve electrochemical performance.

### BACKGROUND ART

A lithium secondary battery comprises a cathode, an anode, a separator interposed between the cathode and the anode to separate them, and an electrolyte electrochemically communicating with the cathode and the anode. Recently, as technology development and demand for mobile devices have increased, the demand for lithium secondary batteries as an energy source has rapidly increased, and as the market for medium- and large-sized lithium secondary batteries such as electric vehicles has grown, research attempting to increase the capacity of lithium secondary batteries is being actively conducted.

Such a lithium secondary battery is generally manufactured by using, as the cathode, a compound in which lithium is inserted, such as LiCoO₂ or LiMn₂O₄, and by using, as the anode, a material such as carbon-based or Si-based in which lithium is not inserted, and during charging, lithium ions inserted in the cathode move to the anode through the electrolyte, and during discharging, the lithium ions move again from the anode to the cathode. During charging, lithium moving from the cathode to the anode reacts with the electrolyte to form, on the surface of the anode, a kind of protective film (passivation film), SEI (solid electrolyte interface). This SEI suppresses the movement of electrons required for the reaction between the anode and the electrolyte, thereby preventing the decomposition reaction of the electrolyte and stabilizing the structure of the anode, while, since it is an irreversible reaction, it leads to the consumption of lithium ions. That is, the lithium consumed by the formation of the SEI does not return to the cathode in the subsequent discharging process, thereby reducing the capacity of the battery, and this phenomenon is called irreversible capacity. In addition, since the charging and discharging efficiency of the cathode and anode of the lithium secondary battery is not completely 100%, as charging/discharging progresses, consumption of lithium ions occurs, causing a reduction in capacity, and thus eventually leading to deterioration of lifetime performance. In particular, when Si-based material is used as the anode for high capacity, the problem of low initial efficiency due to lithium consumption is further raised because the initial irreversible capacity is high.

Accordingly, as a technique for reducing the initial irreversibility of the anode, pre-lithiation, that is, a method of improving the capacity and electrochemical performance of the battery by performing the irreversible reaction of the anode in advance before manufacturing the battery or by preliminarily charging lithium into the anode to secure initial reversibility, has been attempted, but there are cases in which discharge capacity or lifetime performance deteriorates, and in the case of directly using lithium metal for pre-lithiation, there is a problem in that handling is difficult and the risk of fire and explosion is great because lithium itself, having an unstable property in air, easily reacts with oxygen, nitrogen, and carbon dioxide.

### DISCLOSURE OF THE INVENTION

### Technical Problem

The present invention is intended to solve the above problems, and provides a lithium secondary battery that uses an anode comprising lithium and, by controlling the ratio (N/P ratio) of the anode capacity to the cathode capacity and the charging/discharging SOC range, minimizes the amount of lithium loss during the charging/discharging process and improves the initial coulombic efficiency (ICE) and lifetime performance.

The objects of the present invention are not limited to the purposes mentioned above, and other objects and advantages of the present invention not mentioned can be understood by the following description, and will be more clearly understood by the embodiments of the present invention. In addition, it will be easily understood that the objects and advantages of the present invention can be realized by the means and combinations thereof shown in the claims.

### Technical Solution

An embodiment of the present invention for achieving the above object provides a lithium secondary battery comprising a cathode; an anode; a separator interposed between the cathode and the anode; and an electrolyte; wherein the reversible capacity ratio (N/P ratio) of the cathode and the anode is 1.2 to 4.0, and the anode comprises an anode active material comprising lithium.

In an embodiment of the present invention, the anode active material comprising lithium may be pre-lithiated.

In an embodiment of the present invention, the anode active material may comprise lithium silicide (LiₓSi, 0<x<4.4), LiₓSn (0<x<4.4), LiₓGe (0<x<4.4), LiₓAl (0<x<3), LiₓSb (0<x<3), LiₓZn (0<x<1), LiₓC (0<x<0.17), Li₄₊ₓTi₅O₁₂ (0<x<3), LiₓMoO₂ (0<x<4), LiₓTiO₂ (0<x<3), LiₓV₂O₅ (0<x<5), or a mixture of two or more thereof.

In an embodiment of the present invention, the anode active material may comprise lithium silicide (LiₓSi, 0<x<4.4).

In an embodiment of the present invention, the anode active material comprising lithium may be pre-lithiated in a range of 15% or more and 40% or less of SOC.

In an embodiment of the present invention, the reversible capacity ratio of the cathode and the anode may be 1.3 to 3.8, more preferably 1.3 to 3.6, and most preferably 1.3 to 3.0.

In an embodiment of the present invention, the anode active material may have a particle size of 10 nm to 200 μm.

The present invention may provide a method for controlling a lithium secondary battery, comprising a step of setting the charging start SOC to a point between SOC 15% and 40% and controlling a charging/discharging range by SOC Y % from the charging start SOC, wherein Y is in the range of 30 to 50.

In an embodiment of the present invention, Y may be in the range of 30 to 40.

In an embodiment of the present invention, the initial coulombic efficiency (ICE) of the lithium secondary battery may be 80% or more.

The means for solving the above task are not all enumerated as the features of the present invention. Various features of the present invention and advantages and effects thereof can be understood in more detail with reference to the following specific embodiments.

### Advantageous Effects

According to one aspect of the present invention, a lithium secondary battery that improves initial coulombic efficiency and lifetime performance by minimizing the amount of lithium loss during the charging/discharging process can be provided.

According to another aspect of the present invention, a method for controlling a lithium secondary battery that improves the initial coulombic efficiency and lifetime performance of the lithium secondary battery can be provided.

In addition to the above-described effects, the specific effects of the present invention are described together while explaining the specific contents for carrying out the invention below.

### BRIEF DESCRIPTION OF THE DRAWINGS

FIG. 1 is a design of a lithium secondary battery according to an embodiment of the present invention.

FIG. 2 shows the SOC control experiment protocol of the embodiment and the comparative example.

FIG. 3a shows the average lithium loss according to the charging/discharging SOC control range of the lithium secondary batteries of the embodiment and the comparative example.

FIG. 3b is a graph of the change in voltage over time of Comparative Examples 2 and 4 and Example 1.

FIG. 4 shows the capacity retention of Comparative Examples 1 to 6 and Example 1.

FIG. 5a is a voltage-capacity (normalized capacity) curve of Comparative Example 3.

FIG. 5b is a voltage-capacity (normalized capacity) curve of Example 1.

FIG. 5c is a voltage-capacity (normalized capacity) curve of Comparative Example 4.

FIG. 6 is a voltage (V) curve according to capacity of Comparative Example 1, Example 1, a Reference Example, and a Graphite battery, respectively. Here, the capacity is the capacity per mass of active material, calculated by dividing the full cell capacity by the mass of the cathode active material.

FIG. 7a shows the rate characteristics of Reference Example 1, Comparative Examples 1 and 5, Example 1, and a Graphite battery.

FIG. 7b shows the capacity retention of Reference Example 1, Comparative Examples 1 and 5, and Example 1.

FIG. 8 shows the EIS (Electrochemical Impedance Spectroscopy) data of Comparative Example 1 and Example 1 as a Nyquist plot.

### MODE FOR CARRYING OUT THE INVENTION

Hereinafter, the principles of the preferred embodiments of the present invention will be described in detail with reference to the accompanying drawings and description. However, the drawings shown below and the description set forth later are of preferred embodiments among various methods for effectively explaining the features of the present invention, and the present invention is not limited only to the following drawings and description.

Meanwhile, terms such as first or second may be used to describe various components, but such terms should be interpreted only for the purpose of distinguishing one component from another component. For example, a first component may be referred to as a second component, and similarly, the second component may also be referred to as the first component.

Unless the expression of the singular clearly indicates otherwise in the context, it includes the plural expression. In the present specification, terms such as ‘comprise’ or ‘have’ are intended to specify that there are described features, numbers, steps, operations, components, parts, or combinations thereof, but should be understood not to preclude in advance the possibility of the presence or addition of one or more other features, numbers, steps, operations, components, parts, or combinations thereof.

Unless otherwise defined, all terms used herein, including technical or scientific terms, have the same meaning as commonly understood by one of ordinary skill in the art to which this invention belongs. Terms defined in a generally used dictionary should be interpreted as having a meaning consistent with the contextual meaning in the related art, and, unless explicitly defined in the present specification, should not be interpreted in an idealized or excessively formal sense.

In describing the present invention, the numerical range represented using the term ‘to’ indicates a numerical range including the values described before and after the term as a lower limit value and an upper limit value, respectively. When numerical values as the upper limit and the lower limit of any numerical range are disclosed as a plurality, the numerical range disclosed in the present specification can be understood as any numerical range having, as the lower limit value and the upper limit value, any one value among the plurality of lower limit values and any one value among the plurality of upper limit values, respectively.

Hereinafter, the description is mainly given by taking a lithium secondary battery as an example, but the present invention is not limited to the lithium secondary battery and can be applied to various non-aqueous electrolyte lithium secondary batteries.

The present invention provides a lithium secondary battery comprising a cathode; an anode; a separator interposed between the cathode and the anode; and an electrolyte; wherein the reversible capacity ratio (N/P ratio) of the cathode and the anode is 1.2 to 4.0, and the anode comprises an anode active material comprising lithium.

In describing the present invention, the reversible capacity ratio of the cathode and the anode, that is, the N/P ratio, means the anode capacity relative to the cathode capacity that can be reversibly exhibited, and in the present invention, it was calculated using the following equation.

N/P ratio=(Anode reversible capacity)/(Cathode reversible capacity)=(Anode de-lithiation capacity)/(Cathode lithiation capacity−Anode irreversible capacity)

Here, the reversible capacity means the capacity exhibited by the insertion/deintercalation of lithium when a half-cell is manufactured by using each of the cathode and the anode with a lithium metal electrode as a counter electrode and discharging is carried out. For example, the anode reversible capacity means the de-lithiation capacity exhibited when discharging is carried out, and the cathode reversible capacity means the capacity obtained by subtracting the anode irreversible capacity from the lithiation capacity exhibited when discharging is carried out.

Here, the anode irreversible capacity means the amount of lithium consumed due to side-reactions such as an electrolyte reduction reaction, and can be calculated through the coulombic efficiency of the battery.

Meanwhile, discharging of the cathode and the anode may be carried out by applying cutoff voltage conditions commonly used for the cathode and the anode active materials. For example, the anode capacity for lithiation and de-lithiation may be measured under cutoff voltage conditions of 0.01 V to 1.5 V (vs. Li/Li⁺) for the anode and 2.7 V to 4.3 V (vs. Li/Li⁺) for the cathode, but it is not limited to the above voltage ranges.

Meanwhile, the discharging may be carried out under a current condition of 0.05 C-rate to 1.0 C-rate.

The reversible capacity ratio of the cathode and the anode can be controlled through the loading amount of the electrode mixture for each electrode.

In an embodiment of the present invention, the reversible capacity ratio (N/P ratio) of the cathode and the anode may be 1.2 to 4.0, preferably 1.3 to 3.8, more preferably 1.3 to 3.6, and most preferably 1.3 to 3.0.

In an embodiment of the present invention, when the anode comprises an anode active material comprising lithium and, while the N/P ratio, which is the reversible capacity ratio of the cathode and the anode, satisfies the above numerical range, the charging/discharging SOC range of the lithium secondary battery is controlled, the amount of lithium loss due to charging/discharging can be minimized, thereby improving the initial coulombic efficiency and lifetime performance of the lithium secondary battery.

At this time, when only the N/P ratio, which is the reversible capacity ratio of the cathode and the anode, is controlled, at a high N/P ratio, a problem of low initial coulombic efficiency due to an excessive amount of the anode occurs, and at a low N/P ratio, a problem of lithium dendrite precipitation may occur. However, the present invention can improve the initial coulombic efficiency and lifetime performance of the lithium secondary battery by simultaneously controlling the anode comprising an anode active material comprising lithium and the charging/discharging SOC range.

In an embodiment of the present invention, the anode active material of the present invention may comprise lithium. Specifically, the anode active material may comprise a lithium source (Li-source).

In an embodiment of the present invention, the anode active material is not particularly limited as long as lithium ions can be inserted therein, and specific examples thereof include (semi)metals such as Si, Sn, Al, Sb, Zn, and Ge that can be alloyed with lithium, or oxides thereof, metal oxides capable of storing lithium, for example, CoₓO_{y} (1≤x≤3, 1≤y≤4), NiₓO_{y} (1≤x≤2, 1≤y≤3), FeₓO_{y} (1≤x≤5, 1≤y≤5), TiO₂, MoO₂, V₂O₅, Li₄Ti₅O₁₂, and the like; or carbon-based materials capable of storing lithium, such as graphite, hard carbon, and soft carbon, and examples in which lithium ions are inserted into the interior of such materials include lithium silicide (LiₓSi, 0<x<4.4), LiₓSn (0<x<4.4), LiₓGe (0<x<4.4), LiₓAl (0<x<3), LiₓSb (0<x<3), LiₓZn (0<x<1), Co-Li₂O, Ni—Li₂O, Fe—Li₂O, LiₓC (0<x<0.17), Li₄₊ₓTi₅O₁₂ (0<x<3), LiₓMoO₂ (0<x<4), LiₓTiO₂ (0<x<3), LiₓV₂O₅ (0<x<5), and mixtures of two or more thereof. These composites may exist in a state in which various forms are mixed. For example, in the case of lithium silicide (LiₓSi, 0<x<4.4), various forms having several values of x, such as 4.4, 3.75, 3.25, and 2.33, may be mixed in LiₓSi.

In an embodiment of the present invention, the anode active material comprising lithium may be pre-lithiated in a range of 15% or more and 40% or less of SOC.

For example, in the case where x is 3.75 in LiₓSi, the anode active material pre-lithiated by 20% SOC may be Li_{0.75}Si.

FIG. 1 is a new design of a lithium secondary battery according to an embodiment of the present invention.

Referring to FIG. 1, it can be confirmed that when the anode active material comprising lithium, the N/P ratio, which is the reversible capacity ratio of the cathode and the anode, and the charging/discharging SOC range are controlled within an appropriate range, the initial coulombic efficiency and lifetime performance of the lithium secondary battery can be improved.

### Anode

The anode according to the present invention may comprise an anode current collector and an anode mixture disposed on at least one surface of the anode current collector. The anode mixture may comprise an anode active material, a conductive material, and a binder. The anode mixture may be formed by coating an anode slurry comprising an anode active material, a conductive material, a binder, and a solvent on at least one surface of the current collector, followed by drying and rolling.

The coating method of the anode slurry is not particularly limited as long as it is a method commonly used in the art. For example, a coating method using a doctor blade may be used, and in addition, a coating method using a slot die, a gravure coating method, a dip coating method, or a spray coating method may be used.

The anode current collector may serve as a passage for delivering electrons from the outside to the anode active material to cause an electrochemical reaction in the anode active material or for receiving electrons from the anode active material and sending them to the outside.

For example, as the anode current collector, copper, stainless steel, aluminum, nickel, titanium, calcined carbon, or those surface-treated with carbon, nickel, titanium, silver, etc. on the surface of aluminum or stainless steel may be used, and specifically, transition metals such as copper and nickel that well adsorb carbon may also be used as the current collector. For example, the thickness of the anode current collector may be 6 μm to 20 μm, but the thickness of the anode current collector is not limited thereto.

The anode active material of the present invention contains lithium. Specifically, the anode active material may comprise a lithium source (Li-source).

The anode active material is not particularly limited as long as lithium ions can be inserted therein, and specific examples thereof include (semi)metals capable of alloying with lithium such as Si, Sn, Al, Sb, and Zn, or oxides thereof, metal oxides capable of storing lithium, for example, CoₓO_{y} (1≤x≤3, 1≤y≤4), NiₓO_{y} (1≤x≤2, 1≤y≤3), FeₓO_{y} (1≤x≤5, 1≤y≤5), TiO₂, MoO₂, V₂O₅, Li₄Ti₅O₁₂, and the like; or carbon-based materials capable of storing lithium, such as graphite, hard carbon, and soft carbon. Examples in which lithium ions are inserted into the interior of such materials include lithium silicide (LiₓSi, 0<x<4.4), LiₓSn (0<x<4.4), LiₓGe (0<x<4.4), LiₓAl (0<x<3), LiₓSb (0<x<3), LiₓZn (0<x<1), Co—Li₂O, Ni—Li₂O, Fe—Li₂O, LiₓC (0<x<0.17), Li₄₊ₓTi₅O₁₂ (0<x<3), LiₓMoO₂ (0<x<4), LiₓTiO₂ (0<x<3), LiₓV₂O₅ (0<x<5), and mixtures of two or more thereof. These composites may exist in a mixed state of various forms. For example, in the case of lithium silicide (LiₓSi, 0<x<4.4), various forms having values of x such as 4.4, 3.75, 3.25, and 2.33 may be mixed in LiₓSi.

The anode active material may be included in an amount of 50% by weight to 99% by weight, preferably 60% by weight to 99% by weight, and more preferably 70% by weight to 99% by weight, based on the total weight of the anode slurry.

The anode active material may have a particle size of 10 nm to 200 m, preferably 1 to 100 m, and more preferably 2 to 30 m, and when satisfying such a size range, stable charging/discharging can be carried out while minimizing side reactions and resistance.

The conductive material can improve the conductivity between active material particles in the electrode or with the metal current collector, and can prevent the binder from acting as an insulator. The conductive material may be, for example, a mixture of one or more conductive materials selected from the group consisting of graphite, carbon black, carbon nanotubes (CNT), carbon fibers, metal fibers, metal powders, conductive whiskers, conductive metal oxides, activated carbon, and polyphenylene derivatives, and more specifically, may be a mixture of one or more conductive materials selected from the group consisting of natural graphite, artificial graphite, super P, acetylene black, Ketjen black, channel black, furnace black, lamp black, thermal black, Denka black, aluminum powder, nickel powder, zinc oxide, potassium titanate, and titanium oxide.

The binder can suppress separation between the anode active material particles or between the anode and the current collector. As the binder, polymers commonly used in electrodes in the art may be used. Such binders may include, without limitation, poly(vinylidene fluoride-co-hexafluoropropylene), poly(vinylidene fluoride-co-trichloroethylene), poly(methyl methacrylate), poly(ethylhexyl acrylate), poly(butyl acrylate), poly(acrylonitrile), poly(vinylpyrrolidone), poly(vinyl acetate), poly(ethylene-co-vinyl acetate), poly(ethylene oxide), polyacrylate, cellulose acetate, cellulose acetate butyrate, cellulose acetate propionate, cyanoethyl pullulan, cyanoethyl poly(vinyl alcohol), cyanoethylcellulose, cyanoethyl sucrose, pullulan, and carboxyl methyl cellulose, but are not limited thereto.

### Separator

The lithium secondary battery according to the present invention comprises a separator that blocks physical contact between the cathode and the anode and electrically insulates the cathode and the anode.

Specifically, the separator may be composed only of a porous substrate, and, if necessary, may further comprise a coating layer disposed on at least one surface of the porous substrate.

The porous substrate according to the present invention may be a porous structure having high resistance to the electrolyte and fine pore diameters, which can electrically insulate the anode and the cathode to prevent a short circuit while providing a migration path for lithium ions.

The constituent material of the porous substrate is not particularly limited as long as it is an organic material or an inorganic material having electrical insulation properties. The porous substrate may comprise at least one selected from the group consisting of polyolefin, polyethylene terephthalate, polybutylene terephthalate, polyacetal, polyamide, polycarbonate, polyimide, polyaryletheretherketone, polyethersulfone, polyphenylene oxide, polyphenylene sulfide, and polyethylene naphthalate, and specifically may comprise polyolefin. Polyolefin not only has excellent coatability but also can reduce the thickness of the separator to increase the proportion of the electrode mixture in the battery, thereby increasing the capacity per volume. Specifically, the weight average molecular weight (Mw) of the polyolefin may be 100,000 to 500,000 g/mol. If the weight average molecular weight of the polyolefin is less than the above numerical range, it may be difficult to secure sufficient mechanical properties, and if it exceeds the above numerical range, the shutdown function may not be implemented or molding may be difficult. The shutdown function means a function of blocking the movement of ions and preventing thermal runaway of the battery by closing the pores of the porous substrate by melting the thermoplastic resin when the temperature of the lithium secondary battery increases.

The thickness of the porous substrate may be, for example, 3 to 50 m or 4 to 15 m. If the thickness of the porous substrate is less than the numerical range, the function of the conductive barrier may not be sufficient, and if it exceeds the numerical range, the resistance of the separator may excessively increase.

The average diameter of the pores included in the porous substrate may be, for example, 10 to 100 nm. The pores included in the porous substrate have a structure interconnected with each other so that gas or liquid can pass from one surface of the porous substrate to the other surface.

The coating layer according to the present invention can improve the mechanical strength and heat resistance of the separator for the lithium secondary battery, and can increase the ionic conductivity in the lithium secondary battery.

The coating layer according to the present invention is disposed on one surface of the porous substrate. Specifically, since the coating layer is disposed only on one surface of the porous substrate, it may be advantageous to the energy density of the battery because the amount of the electrode active material can be increased by the reduced thickness compared to both surfaces.

The packing density of the coating layer may be 0.1 to 20 g/cm³, specifically 0.5 to 12 g/cm³, and more specifically 1 to 3 g/cm³. When the packing density of the coating layer satisfies the numerical range, the permeability of lithium ions may be advantageous, and the heat resistance of the separator may be maintained at an appropriate level. Meanwhile, the packing density is the density of the coating layer loaded per 1 μm in height per unit area (m²) of the porous substrate.

The thickness of the coating layer may be 0.1 to 10 μm, specifically 1 to 3 μm, and more specifically 1.4 to 1.6 μm. When the thickness of the coating layer satisfies the above numerical range, the insulation and thermal stability of the separator can be improved, and at the same time, the energy density of the battery can be enhanced.

The coating layer according to the present invention may comprise a binder polymer and inorganic particles.

The binder polymer according to the present invention can connect and stably fix the inorganic particles. The binder polymer may be used by mixing one or more selected from the group consisting of poly(vinylidene fluoride-co-hexafluoropropylene), poly(vinylidene fluoride-co-trichloroethylene), polymethylmethacrylate, polyacrylonitrile, polyvinylpyrrolidone, polyvinyl acetate, poly(ethylene-co-vinyl acetate), polyethylene oxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxyl methyl cellulose, acrylonitrile-styrene butadiene copolymer, polyimide, and styrene-butadiene rubber.

In another embodiment of the present invention, the weight ratio of the inorganic particles to the binder polymer (inorganic particles:binder polymer) may be 50:50 to 99:1, and specifically 70:30 to 95:5. If the content ratio of the inorganic particles to the binder polymer is less than the above numerical range, the content of the binder polymer increases, thereby reducing the performance of improving the thermal safety of the separator, and due to the reduction of the empty space formed between the inorganic particles, the pore size and porosity decrease, which may cause deterioration of the performance of the final battery. If it exceeds the above numerical range, the content of the binder polymer becomes too small, which may weaken the peel strength of the coating layer.

The inorganic particles according to the present invention can contribute to improving the mechanical strength and heat resistance of the separator for the lithium secondary battery. Specifically, the inorganic particles are not particularly limited as long as they are electrochemically stable. That is, the inorganic particles usable in the present invention are not particularly limited as long as oxidation and/or reduction reactions do not occur within the operating voltage range of the applied lithium secondary battery (for example, 0-5 V based on Li/Li⁺)

### Cathode

The cathode according to the present invention may comprise a cathode current collector and a cathode mixture disposed on at least one surface of the cathode current collector. The cathode mixture may comprise a cathode active material, a conductive material, and a binder.

For example, the cathode current collector is not particularly limited as long as it has high conductivity without causing chemical changes in the battery. Specifically, as the cathode current collector, copper, stainless steel, aluminum, nickel, titanium, calcined carbon, those surface-treated with carbon, nickel, titanium, silver, etc. on the surface of copper or stainless steel, or aluminum-cadmium alloy may be used. The cathode current collector may generally have a thickness of 6 to 20 μm.

The cathode active material is a compound capable of reversible intercalation and deintercalation of lithium, and specifically may comprise a lithium composite metal oxide comprising lithium and at least one metal selected from the group consisting of nickel (Ni), cobalt (Co), manganese (Mn), iron (Fe), and aluminum (Al).

More specifically, the lithium composite metal oxide may be a lithium-manganese-based oxide (for example, LiMnO₂, LiMn₂O₄, etc.), a lithium-cobalt-based oxide (for example, LiCoO₂, etc.), a lithium-nickel-based oxide (for example, LiNiO₂, etc.), a lithium-nickel-manganese-based oxide (for example, LiNi_{1-y}_{₁}Mn_{y}_{₁}O₂ (where 0<y₁<1), LiMn_{2-z}_{₁}Ni_{z}_{₁}O₄ (where 0<z₁<2), etc.), a lithium-nickel-cobalt-based oxide (for example, LiNi₁-y₂Coy₂O₂ (where 0<y₂<1), etc.), a lithium-manganese-cobalt-based oxide (for example, LiCo₁-y₃Mn y₃O₂ (where 0≤y₃<1), LiMn_{2-z}_{₂}Co z₂O₄ (where 0<z₂<2), etc.), a lithium-nickel-manganese-cobalt-based oxide (for example, Li(Ni p₁Co q₁Mn r₁)O₂ (where 0<p₁<1, 0<q₁<1, 0<r₁<1, and p₁+q₁+r₁=1), a lithium-nickel-manganese-aluminum-based oxide Li(Ni p₂Co q₂Al r₂)O₂ (where 0<p₂<2, 0<q₂<2, 0<r₂<2, and p₂+q₂+r₂=1), etc.), or a lithium-nickel-cobalt-transition metal (M) oxide (for example, Li(Ni p₃Co q₃Mn r₃M s₃)O₂ (where M is selected from the group consisting of Al, Fe, V, Cr, Ti, Ta, Mg, and Mo, and p₃, q₃, r₃, and s₃ are each independently the atomic fraction of the element, and 0<p₃<1, 0<q₃<1, 0<r₃<1, 0<s₃<1, and p₃+q₃+r₃+s₃=1)), and the cathode active material may include any one thereof alone or two or more thereof.

The conductive material used in the cathode may be the same as or different from the conductive material used in the anode.

### Electrolyte

The electrolyte according to the present invention may comprise a solvent and a lithium salt.

The solvent according to the present invention may be one or a mixture of two or more selected from the group consisting of propylene carbonate (PC), ethylene carbonate (EC), diethyl carbonate (DEC), dimethyl carbonate (DMC), dipropyl carbonate (DPC), dimethyl sulfoxide, acetonitrile, dimethoxyethane, diethoxyethane, tetrahydrofuran, N-methyl-2-pyrrolidone (NMP), ethylmethyl carbonate (EMC), gamma-butyrolactone (GBL), methyl formate, ethyl formate, propyl formate, methyl acetate, ethyl acetate, propyl acetate, pentyl acetate, methyl propionate, ethyl propionate, propyl propionate, and butyl propionate.

The lithium salt according to the present invention may comprise, for example, anions such as NO₃⁻, F⁻, Cl⁻, Br⁻, I⁻, PF₆⁻, FSI⁻, and TFSI⁻. Here, FSI is bis(fluorosulfonyl)imide, and TFSI is bis(trifluoromethylsulphonyl)imide.

If necessary, the electrolyte according to the present invention may further comprise an additive that contributes to protecting the surface of the electrode so that charging and discharging can be carried out more stably when lithium ions move. For example, the additive may be one or a mixture of two or more selected from the group consisting of fluoroethylene carbonate (FEC), cyclohexylbenzene, biphenyl, vinylene carbonate, succinic anhydride, ethylene sulfite, propylene sulfite, dimethyl sulfite, propanesultone, butanesultone, methyl methanesulfonate, methyl toluenesulfonate, dimethyl sulfate, ethylene sulfate, sulfolane, dimethyl sulfone, diethyl sulfone, dimethyl sulfoxide, diethyl sulfoxide, tetramethylene sulfoxide, diphenyl sulfide, thioanisole, diphenyl disulfide, and dipyridinium disulfide.

The lithium secondary battery according to the present invention may be a cylindrical, prismatic, or pouch-type lithium secondary battery, but is not particularly limited as long as it corresponds to a charging and discharging device.

Another embodiment of the present invention can provide a battery module comprising the lithium secondary battery as a unit cell and a battery pack comprising the same. The battery pack may be used as a power source for one or more medium- and large-sized devices selected from the group consisting of a power tool; an electric vehicle (EV), a hybrid electric vehicle (HEV), and a plug-in hybrid electric vehicle (PHEV) comprising an electric car; or a power storage system.

### 2. Method for Controlling Lithium Secondary Battery

Another embodiment of the present invention is a method for controlling a lithium secondary battery of the present invention, and may provide a method for controlling a lithium secondary battery comprising, during charging/discharging of the lithium secondary battery of the present invention, a step of setting the charging start SOC to a point between SOC 15% and 40% and controlling the charging/discharging range by SOC Y % from the charging start SOC.

At this time, Y may have a range of 30 to 50 or 30 to 40.

For example, when the charging start SOC is set to SOC 30% and Y is 40, the method for controlling a lithium secondary battery of the present invention may comprise a step of controlling the charging/discharging range to SOC 30 to 70% during charging/discharging.

The charging start SOC can be adjusted through pre-lithiation of the anode.

As methods of pre-lithiation of the anode, electrochemical pre-lithiation methods, mechanical pre-lithiation methods, chemical pre-lithiation methods, and metallurgical pre-lithiation methods are mainly used.

Electrochemical pre-lithiation is a method of performing pre-lithiation by manufacturing a battery with a target electrode, for example, a silicon electrode and lithium metal as a counter electrode, and then applying a current.

Mechanical pre-lithiation is a method of performing alloying of lithium metal and silicon by physically contacting a target electrode, for example, a silicon electrode, with lithium metal. For example, when thin lithium metal (thickness: 20 μm) is brought into contact with a silicon electrode and high pressure is applied, lithium and silicon form an alloy and pre-lithiation proceeds.

Meanwhile, in the mechanical pre-lithiation method, after physically contacting the silicon electrode with lithium metal, an electrolyte may be injected and pressure may be applied.

When pressure is applied in the presence of the electrolyte, electrons move from the lithium metal to the silicon, and lithium ions are eluted into the electrolyte to balance the charge. Then, the electrons that have moved to the silicon and the lithium ions in the electrolyte meet on the surface of the silicon, and pre-lithiation proceeds.

Chemical pre-lithiation is a method of performing pre-lithiation by immersing a target electrode, for example, a silicon electrode, in a solvent in which lithium ions are dissolved, and proceeding with pre-lithiation by adjusting the reduction potential of the target electrode and the solvent.

Metallurgical pre-lithiation is a method of performing pre-lithiation by reacting molten lithium with a target electrode, for example, a silicon electrode, and proceeding with pre-lithiation through alloying of lithium and silicon.

In the present invention, the pre-lithiation of the anode is sufficient as long as it is a method by which the anode active material and lithium can form an alloy, and is not limited to the specific pre-lithiation methods described above.

The silicon-based anode active material undergoes a very large volume change (for example, 300% or more) during charging/discharging, resulting in structural collapse of the active material and detachment of the active material from the current collector, thereby increasing resistance due to electrical contact loss. In cases where volume expansion/contraction is severe as described above, the SEI (Solid Electrolyte Interphase) film is broken, and lithium is continuously lost for the formation of a new SEI film, thereby rapidly reducing the lifetime of the battery.

In an embodiment of the present invention, during charging/discharging of the lithium secondary battery, by setting the charging start SOC to a point between SOC 15% and 40% and controlling the charging/discharging range by SOC Y % from the charging start SOC (at this time, Y has a range of 30 to 50), the amount of lithium loss can be minimized, thereby improving the lifetime performance of the lithium secondary battery.

Hereinafter, embodiments of the present invention will be described in detail so that those skilled in the art to which the present invention pertains can easily carry out the invention, but these are merely examples, and the scope of rights of the present invention is not limited by the following description.

### Manufacturing Example 1: Manufacture of Lithium Secondary Battery

### Manufacture of Anode

Si having an average particle diameter (D50) of 5 μm, a binder (CMC:SBR=7.5:12 (w/w)), and a conductive material (CNT) were put into a solvent (distilled water) at a weight ratio of 80:19.5:0.5, and then stirred at 2,000 rpm for 30 minutes to prepare an anode slurry. The anode slurry was applied to a copper thin film (thickness: 10 m) using a doctor blade, and then dried at 110° C. overnight to manufacture a Si anode.

After laminating in the order of the Si anode, a separator, and lithium metal, an electrode assembly was manufactured by lamination. After loading the electrode assembly into a coin cell case, an electrolyte was injected to manufacture a half-cell comprising Si as the anode. The electrolyte comprises: a lithium salt (1.3 M LiPF₆); a mixed solvent in which ethylene carbonate (EC), ethyl methyl carbonate (EMC), and diethyl carbonate (DEC) are mixed at a volume ratio of 3:5:2; and an additive comprising 0.2 wt % of LiBF₄, 10.0 wt % of fluoroethylene carbonate (FEC), 0.5 wt % of vinylene carbonate, and 1.0 wt % of propane sultone.

Thereafter, for the half-cell comprising Si as the anode, charging and discharging were performed using an electrochemical charge/discharge device to carry out electrochemical pre-lithiation.

For example, when a charge amount corresponding to SOC 10% is applied, Li_{0.375}Si is formed; when a charge amount corresponding to SOC 20% is applied, Li_{0.75}Si is formed; when a charge amount corresponding to SOC 30% is applied, Li_{1.125}Si is formed; when a charge amount corresponding to SOC 40% is applied, Li_{1.5}Si is formed; when a charge amount corresponding to SOC 50% is applied, Li_{1.875}Si is formed; when a charge amount corresponding to SOC 60% is applied, Li_{2.25}Si is formed; when a charge amount corresponding to SOC 70% is applied, Li_{2.625}Si is formed; when a charge amount corresponding to SOC 80% is applied, Li₃Si is formed; when a charge amount corresponding to SOC 90% is applied, Li_{3.375}Si is formed; and when a charge amount corresponding to SOC 100% is applied, Li_{3.75}Si is formed.

As described above, the charging start SOC can be adjusted through pre-lithiation of the anode.

### Manufacture of Cathode

A cathode slurry was prepared by putting a cathode active material (LiNi_{0.89}Co_{0.08}Mn_{0.03}O₂(NCM89)), a binder (PVDF), a conductive material (Super P), and a conductive material (CNT) into a solvent (NMP) at a weight ratio of 92:4:3:1, and then stirring at 2,000 rpm for 30 minutes. The cathode slurry was applied to an aluminum thin film with a thickness of 20 μm (thickness: 10 μm) using a doctor blade, and then dried at 110° C. overnight to manufacture the cathode.

At this time, the electrode loading amount was adjusted so that the ratio of the cathode reversible capacity to the anode reversible capacity, N/P ratio, had a value of 2.5 to 2.7.

### Manufacture of Lithium Secondary Battery

After laminating in the order of the cathode, the separator, and the anode, an electrode assembly was manufactured by lamination. After loading the electrode assembly into a coin cell case, an electrolyte was injected to manufacture a lithium secondary battery. The electrolyte comprises: a lithium salt (1.3 M LiPF₆); a mixed solvent in which ethylene carbonate (EC), ethyl methyl carbonate (EMC), and diethyl carbonate (DEC) are mixed at a volume ratio of 3:5:2; and an additive comprising 0.2 wt % of LiBF₄, 10.0 wt % of fluoroethylene carbonate (FEC), 0.5 wt % of vinylene carbonate, and 1.0 wt % of propane sultone.

### [Method for Controlling Lithium Secondary Battery]

For the coin cell manufactured as described above, charging and discharging were performed using an electrochemical charge/discharge device. At this time, charging was performed by constant current charging at a current of 3.0 C-rate, followed by constant voltage charging with 0.05 C-rate as the cutoff current, and discharging was performed by constant current discharging at a current of 1.0 C-rate.

At this time, the charging time was adjusted through a time cutoff condition so that the total charging time was less than 20 minutes. That is, if either one of the charging condition including the above-described constant current and constant voltage cutoff conditions or the charging condition including the 20-minute time cutoff condition was satisfied, charging of the coin cell was terminated and discharging was performed.

The discharge capacity of the half-cell comprising Si as the anode manufactured in [Manufacturing Example 1] was set to SOC 100%, and based on this, the applied charge amount was adjusted to control the SOC of the battery.

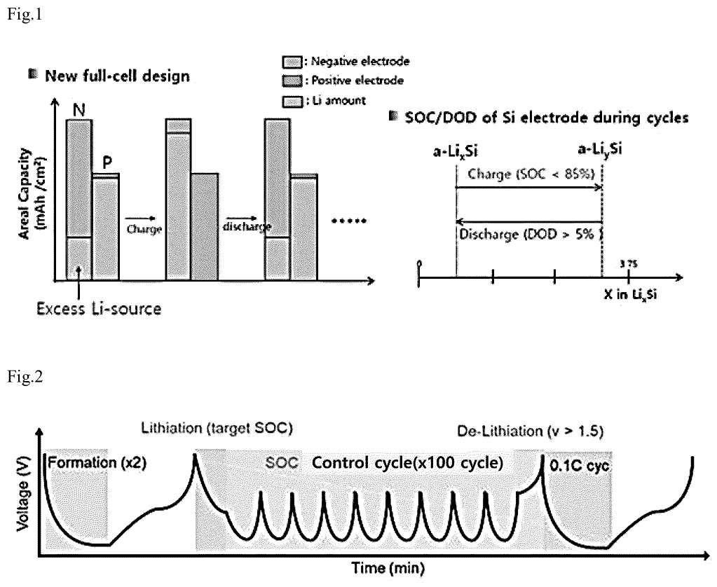

FIG. 2 shows the SOC control experiment protocol of the embodiment and the comparative example, and in FIG. 2, charging/discharging was performed by controlling SOC as described in the embodiment and the comparative example during 100 cycles indicated as ‘SOC control cycle’.

### Example 1

During charging/discharging of the lithium secondary battery manufactured according to Manufacturing Example 1, charging/discharging was performed by controlling the SOC to 30 to 70%.

### Comparative Example 1

In the case of Comparative Example 1, charging/discharging was performed in the same manner as in Example 1, except that during charging/discharging of the lithium secondary battery, the SOC was controlled to 0 to 40%.

### Comparative Example 2

In the case of Comparative Example 2, except that charging/discharging of the lithium secondary battery was performed by controlling the SOC to 10 to 50% during charging/discharging, the lithium secondary battery was controlled in the same manner as in Example 1.

### Comparative Example 3

In the case of Comparative Example 3, except that charging/discharging of the lithium secondary battery was performed by controlling the SOC to 20 to 60% during charging/discharging, the lithium secondary battery was controlled in the same manner as in Example 1.

### Comparative Example 4

In the case of Comparative Example 4, except that charging/discharging of the lithium secondary battery was performed by controlling the SOC to 40 to 80% during charging/discharging, the lithium secondary battery was controlled in the same manner as in Example 1.

### Comparative Example 5

In the case of Comparative Example 5, except that charging/discharging of the lithium secondary battery was performed by controlling the SOC to 50 to 90% during charging/discharging, the lithium secondary battery was controlled in the same manner as in Example 1.

### Comparative Example 6

In the case of Comparative Example 6, except that charging/discharging of the lithium secondary battery was performed by controlling the SOC to 60 to 100% during charging/discharging, the lithium secondary battery was controlled in the same manner as in Example 1.

TABLE 1

| Classification | Indication | Charge/Discharge SOC Range |
|---|---|---|
| Comparative Example 1 | R1 | 0~40% |
| Comparative Example 2 | R2 | 10~50% |
| Comparative Example 3 | R3 | 20~60% |
| Example 1 | R4 | 30~70% |
| Comparative Example 4 | R5 | 40~80% |
| Comparative Example 5 | R6 | 50~90% |
| Comparative Example 6 | R7 | 60~100% |

### Experimental Example 1: Average Lithium Loss Amount According to Charge/Discharge SOC Range of Lithium Secondary Battery

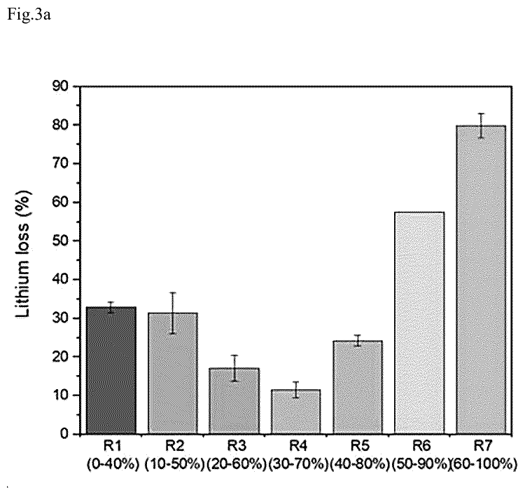

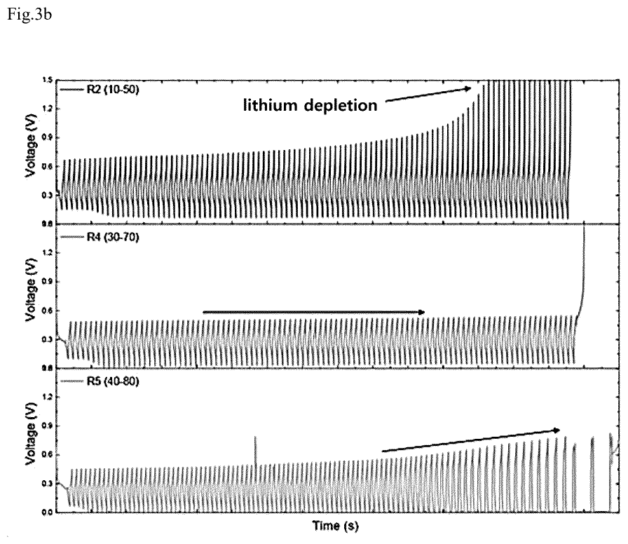

FIG. 3a shows the average lithium loss according to the charge/discharge SOC range of the lithium secondary batteries of the Examples and Comparative Examples. The average lithium loss shown in FIG. 3a was calculated by summing the irreversible capacity (Lithiation-Delithiation) up to the SOC control cycle region.

Referring to FIG. 3a, it can be confirmed that, during charging/discharging of the lithium secondary battery, the average lithium loss is the least when charging/discharging is repeated in the section where the charge/discharge SOC range is controlled to 30 to 70%.

FIG. 3b is a curve of voltage change over time in Comparative Examples 2 and 4 and Example 1.

Comparing Comparative Example 2 and Example 1 in FIG. 3b, in the case of Example 1, by controlling the charge/discharge SOC range to 30 to 70%, stable charging/discharging is achieved, whereas in the case of Comparative Example 2, it can be confirmed that the cumulative irreversible capacity is large, and the voltage rapidly increases.

### Experimental Example 2: Measurement of Capacity Retention (Cycle Retention) of Lithium Secondary Battery

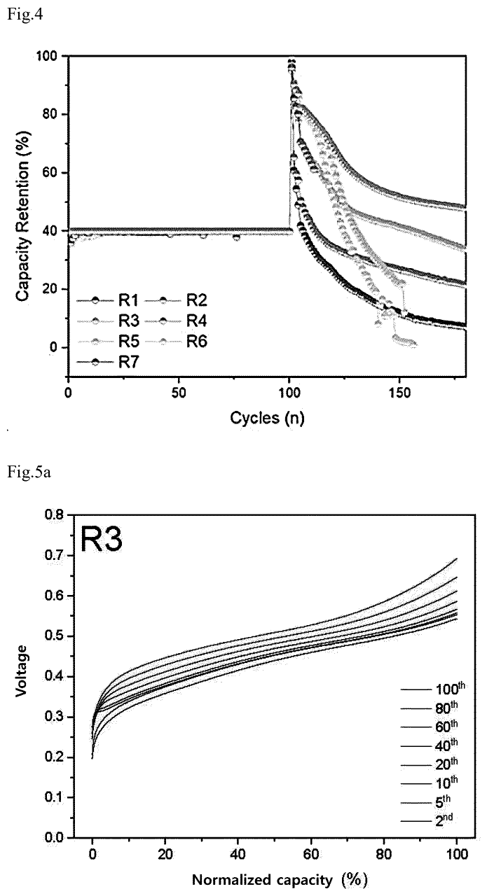

FIG. 4 shows the results of capacity retention of Comparative Examples 1 to 6 and Example 1, performed after SOC control cycles for 100 cycles. After the SOC control cycles, constant current charging/discharging was performed at a current of 0.2 C-rate in a voltage range of 0.01 V to 1.5 V, and in the case of charging, constant voltage charging was performed at the end of charging with 0.01 C-rate as the cutoff current.

Referring to FIG. 4, it can be confirmed that Example 1 shows the highest capacity retention after the SOC control cycles compared to Comparative Examples 1 to 6. That is, in the case of controlling the charge/discharge SOC range of the battery to 30 to 70%, it can be indirectly confirmed that electrode damage of the lithium secondary battery due to lithium loss or volume expansion of the electrode is the least.

### Experimental Example 3: Normalized Voltage-Capacity Curve of Lithium Secondary Battery

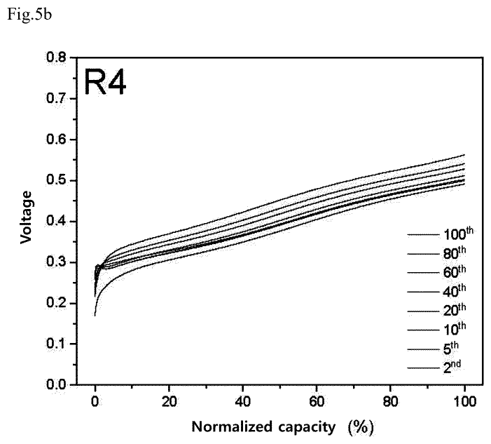

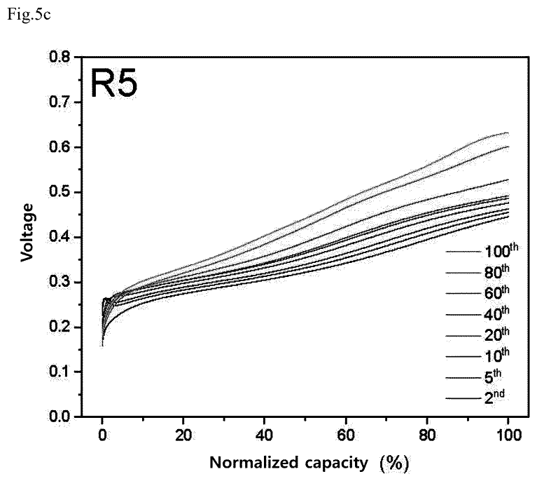

FIGS. 5a to 5c are voltage-capacity (normalized capacity) curves of Comparative Examples 3 and 4 and Example 1.

Referring to FIGS. 5a to 5c, in Example 1, as the charge/discharge cycles increase, hysteresis of the voltage curve does not significantly appear, so that the internal resistance of the lithium secondary battery is low (FIG. 5b), whereas in Comparative Examples 3 and 4 (FIGS. 5a and 5c), as the charge/discharge cycles increase, hysteresis of the voltage curve significantly appears, and it can be confirmed that the internal resistance of the lithium secondary battery increases.

### Experimental Example 4: Voltage-Capacity Curve of Lithium Secondary Battery

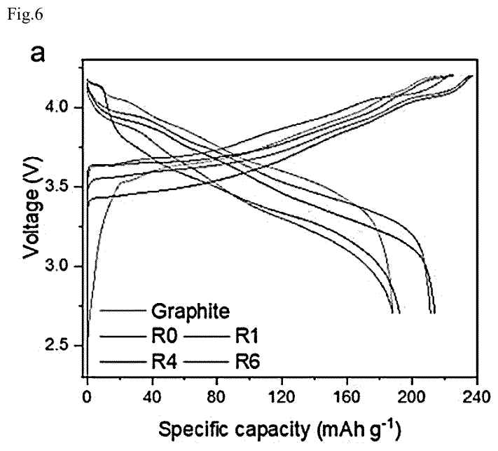

FIG. 6 is a voltage-capacity curve of each of Comparative Examples 1 and 5, Example 1, and the lithium secondary battery comprising graphite as a negative electrode active material. Here, R0 (Reference Example 1) represents a lithium secondary battery in which SOC control was not performed and charging/discharging was carried out on a lithium secondary battery having a general N/P ratio of a lithium secondary battery, that is, a lithium secondary battery in which the N/P ratio was set to 1.1.

Referring to FIG. 6 and Table 2 below, Example 1 showed higher capacity and initial coulombic efficiency compared to the lithium secondary battery comprising graphite as a negative electrode active material (hereinafter referred to as “graphite battery”). In addition, Example 1 showed relatively higher initial coulombic efficiency compared to Comparative Examples 1 and 5 by controlling the charge/discharge SOC to 30 to 70%.

TABLE 2

| | Reference | Comparative | | |
|---|---|---|---|---|
| | Example 1 | Example 1 | Example 1 | Graphite |
| Indication | R0 | R1 | R4 | — |
| Initial Coulombic | 85.4 | 83.5 | 90.1 | 86.3 |
| Efficiency (%) | | | | |

### Experimental Example 5: Rate Characteristics

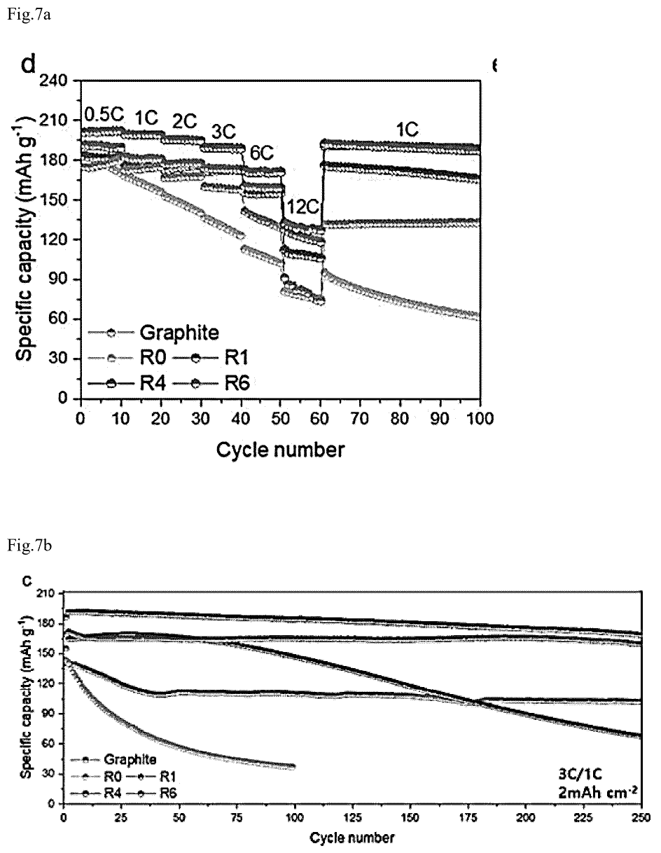

FIG. 7a shows the rate capability of Reference Example 1, Comparative Examples 1 and 5, Example 1, and the graphite battery.

Referring to FIG. 7a, it can be confirmed that Example 1 exhibits superior rate capability compared to Reference Example 1, Comparative Examples 1 and 5, and the graphite battery in less than 50 charge/discharge cycles.

FIG. 7b is the capacity retention according to cycles of Reference Example 1, Comparative Examples 1 and 5, and Example 1.

Referring to FIG. 7b, it can be confirmed that Example 1 shows the highest capacity retention compared to Reference Example 1 and Comparative Examples 1 and 5 during 250 charge/discharge cycles.

### Experimental Example 6: Electrochemical Performance Evaluation of Lithium Secondary Battery

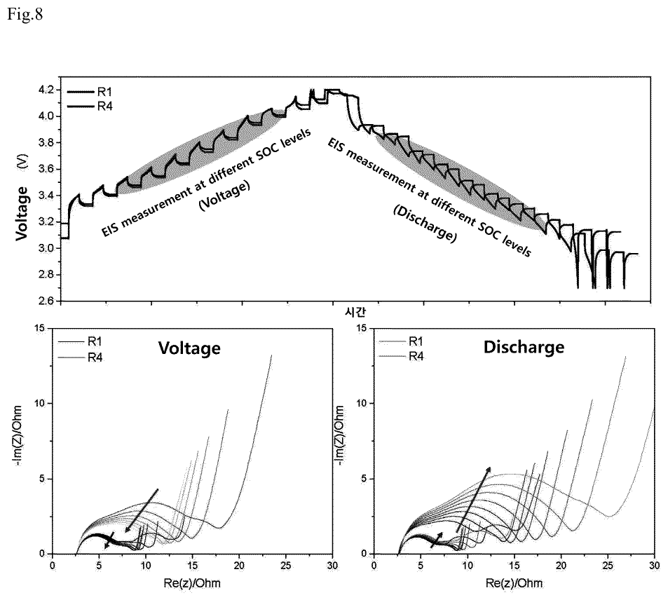

FIG. 8 shows the Nyquist plot measured by electrochemical impedance spectroscopy (EIS) of Comparative Example 1 and Example 1.

Referring to FIG. 8, it can be confirmed that Example 1 shows lower resistance in both the charging and discharging processes compared to Comparative Example 1.

Although preferred embodiments of the present invention have been described in detail above, the scope of the present invention is not limited thereto, and various modifications and improvements by those skilled in the art using the basic concept of the present invention defined in the following claims also belong to the scope of the present invention.

What is claimed is:

1. A lithium secondary battery comprising: a cathode; an anode; a separator interposed between the cathode and the anode; and an electrolyte;
wherein a reversible capacity ratio (N/P Ratio) of the anode to the cathode is 1.2 to 4.0, and the anode comprises an anode active material comprising lithium.

2. The lithium secondary battery according to claim 1, wherein the anode active material comprising lithium is pre-lithiated.

3. The lithium secondary battery according to claim 2, wherein the anode active material comprising lithium comprises lithium silicide (LiₓSi, 0≤x≤4.4), LiₓSn (0≤x≤4.4), LiₓGe (0≤x≤4.4), LiₓAl (0≤x≤3), LiₓSb (0≤x≤3), LiₓZn (0≤x≤1), LiₓC (0≤x≤0.17), Li₄₊ₓTi₅O₁₂ (0≤x≤3), LiₓMoO₂ (0≤x≤4), LiₓTiO₂ (0≤x≤3), LiₓV₂O₅ (0≤x≤5), or a mixture of two or more thereof.

4. The lithium secondary battery according to claim 3, wherein the anode active material comprising lithium comprises lithium silicide (LiₓSi, 0≤x≤4.4).

5. The lithium secondary battery according to claim 3, wherein the anode active material comprising lithium is pre-lithiated in a range of SOC 15% or more to SOC 40% or less.

6. The lithium secondary battery according to claim 1, wherein the reversible capacity ratio (N/P Ratio) of the cathode to the anode is 1.3 to 3.8, or 1.3 to 3.6, or 1.3 to 3.0.

7. The lithium secondary battery according to claim 1, wherein the anode active material comprising lithium has a particle size of 10 nm to 200 μm.

8. A control method of the lithium secondary battery according to claim 1, comprising a step of controlling a charge/discharge range by setting a charge start SOC to a point within SOC 15 to 40% and controlling the charge/discharge range from the charge start SOC by SOC Y %, wherein Y is in a range of 30 to 50.

9. The control method of the lithium secondary battery according to claim 8, wherein Y is in a range of 30 to 40.

10. The control method of the lithium secondary battery according to claim 8, wherein the initial coulombic efficiency (ICE) of the lithium secondary battery is 80% or more.
